(19) United States
(12) Patent Application Publication
(10) Pub. No.: US 2017/0313392 A1
(43) Pub. Date: Nov. 2, 2017

(54) PORTABLE, SINGLE SUPPORT STAKE RACK FOR SURFBOARDS AND THE LIKE

(71) Applicant: Scot Houston Goodman, Virginia Beach, VA (US)

(72) Inventor: Scot Houston Goodman, Virginia Beach, VA (US)

(21) Appl. No.: 15/140,872

(22) Filed: Apr. 28, 2016

(51) Int. Cl. B63B 35/79; A45F 3/00; A45F 3/44; F16B 1/00

(52) U.S. Cl. CPC B63B 35/7946; A45F 3/44; F16B 1/00; A45F 3/00; F16B 2001/0028; A45F 2003/003

(57) ABSTRACT

A single support stake surfboard support for elevating surfboards above a sandy beach. An elongated, hollow support stake, typically having a diagonal cut at its distal end to facilitate pressing the support stake into sand or other terrain. A T-support arm is removably, frictionally attached to a proximal end of the hollow support stake. In a first embodiment, cylindrical polymer cushions are disposed along the T-support arm. In the first embodiment, one or more surfboards may be laid flat across the pair of supports. In a second embodiment, at least two upwardly projecting members are attached to the distal and proximal ends of the T-support arm. Each of the upwardly projecting members may also have one or more cylindrical polymer cushions thereupon. In the second embodiment, up to four surfboards may be accommodated on edge between the upwardly projecting members.

### FIELD OF THE INVENTION

The invention pertains to racks for elongated objects and, more particularly, to portable, single-stake, collapsible racks for surfboards and the like for supporting such objects above sand.

### BACKGROUND OF THE INVENTION

Surf boarding has become an extremely popular sport. As is true in many other sports, surfboards have become increasingly refined and often very expensive. Most surfers (i.e., surfboarders) are close to fanatical in protecting their surfboards. As surfing usually takes place by an ocean shore, protection is often needed from a sand or pebble beach.

Surfers discover there is rarely a place to rest their board when they are not surfing. No surfer would chose to put his or her surfboard on the sand because there is a high probability that sand will stick to the waxed surface(s) of the surfboard. Once this occurs, the only way to remove the sand is to de-wax and then re-wax the surfboard, both time consuming processes. Sand on a waxed surfboard may cause a rash or even cuts on the surfer's body when surfing. In addition the strength of the wax may be reduced.

In addition, placing a surfboard on the sand increases the probability of the surfboard being stepped or sat on. This may cause a variety of damage to the surfboard itself or its fin(s). All surfers go to great extremes to protect their surfboards from sand or physical damage. They may lay their surfboard across a trash container, across beach chairs, propped up against the back of a beach chair. Using a trash container is typically unsanitary for the surfer and inconvenient for other persons on the beach. Using beach chairs makes those chairs unavailable to other people for use as chairs. Chairs may also damage the surfboard or, potentially injure someone who attempts to sit in a chair supporting a surfboard. Using other improvised storage solutions may result in a surfboard being moved by someone other than the surfer, often resulting in damage to the surfboard.

It would, therefore, be advantageous to provide a light-weight, portable support for one or more surfboards that may be used in sand or on other such terrains.

### DISCUSSION OF THE RELATED ART

Several attempts to provide supports to keep surfboards above a sandy beach may be found in the prior art. For example U.S. Pat. No. 3,527,354 for WATER SKI RACK issued Sep. 8, 1970 to Norton D. Sokolow discloses a two legged water ski rack adapted for hanging over the gunwale of a boat.

U.S. Pat. No. 5,082,123 for SPORTING GOODS RACK issued Jan. 21, 1992 to Rocky D. Lamb teaches a wall-mounted sporting goods rack.

U.S. Pat. No. 5,316,155 for SKI RACK issued May 31, 1994 to Anthony P. Collins, et al. shows a ski rack which includes a frame from which extends a ski retaining section, the ski retaining section being dimensioned and adapted to support a set of skis by a binding of the skis.

U.S. Pat. No. 5,598,996 for ADJUSTABLE TARGET STAND issued Feb. 4, 1997 to Scott A. Rath shows stand for a large target with a pair of inwardly angled legs.

U.S. Pat. No. 6,390,309 for SPORTING EQUIPMENT HAMMOCK issued May 21, 2002 to Timothy R. Tucker discloses an apparatus for holding sporting equipment. The rack includes a pair of U-shaped arms spaced apart from one another and in a generally equivalent horizontal position. At least one flexible longitudinal support is suspended between the arms and at least one flexible lateral support is suspended between opposing ends of each arm so that lateral and longitudinal supports, in combination, support the sporting equipment thereon without contacting the arms.

U.S. Pat. No. 6,457,619 for TRUCK BED MOUNTED SURFBOARD STORAGE RACK issued Oct. 1, 2002 to Michael P. Werner, et al. teaches a truck bed mounted surfboard storage rack which aids in the storage and transportation of surfboards via pickup trucks and vans. Two fold up arms have three slots in each one, with each slot being padded with a weatherproof foam material. When extended in the up position, the slots allow up to three surfboards to be stored in a horizontal position on their long edge.

U.S. Pat. No. 6,678,991 for FISHING POLE HOLDER issued Jan. 20, 2004 to Cecil D. Hooks, et al. provides a portable fishing pole holder and carrier with a tubular metal frame. A row of posts projects out-of-plane at each end of the frame for cradling one or more fishing poles, which are held in place by elastic cords. Support members depending from the frame hold the frame above a surface or adjacent to it for compact hand carrying.

U.S. Pat. Nos. 8,002,126 and 8,157,110, both for PORTABLE SURF BOARD RACK AND HOLDER issued Aug. 23, 2011, and Apr. 17, 2012, respectively to Jerry Drum teaches an apparatus for supporting and holding items including surfboards, fishing rods, beach items and tabletops in horizontal positions raised above ground surfaces such as at the beach, and be easily transported, assembled, and disassembled when not being used. The racks can include a pair of horizontal beams. Each of the beams can have typically two legs pivotally attached to ends of each beam. The legs can have storage positions with the legs folded up and parallel to the beams, and extended positions with the legs perpendicular to the beams and having lower ends staked into the ground. The rack can support tabletops and surfboards in horizontal flat positions on top of the assembled horizontal beams. Fishing rods can be stored in horizontal positions in cradle shaped concave recesses so that the fishing rods can be between the surfboards/table tops and the horizontal beams. A storage bag can be used to carry and transport a folded tabletop and folded legs and beams.

Published United States Patent Application No. 2003/0178382 for SPORTING EQUIPMENT SUPPORT SYSTEM published Sep. 25, 2003 upon application by Timothy R. Tucker discloses an apparatus for holding sporting equipment. The apparatus includes a pair of J-shaped or I-shaped tubular arms spaced apart from one another and in a generally equivalent horizontal position. At least one flexible support is suspended between the opposing ends of each tubular arm so that lateral supports, in combination, support the sporting equipment thereon without the equipment contacting the arms.

None of the patents and published patent application, taken singly, or in any combination are seen to teach or suggest the PORTABLE, SINGLE SUPPORT STAKE RACK FOR SURFBOARDS AND THE LIKE of the present invention.

### SUMMARY OF THE INVENTION

In accordance with the present invention there is provided a support system for elevating surfboards above a sandy beach. Each support system uses two supports. Each support has a single elongated, hollow support stake. The support stake has a diagonal cut at its distal end to facilitate pressing or pounding the support stake into sand. Sand is forced into the interior of the support stake thereby contributing to the rigidity of the support stake. The use of a single support stake provides ease of adjustability of each of the pair of supports to maintain a support surface parallel to the terrain. Further, the combination of a single support stake and a T-support arm allows one-handed insertion of the stake into the sand, etc. by a user, while supporting his/her surfboard. A single support stake is further advantageous on rocky or otherwise uneven terrain where inserting a single stake may be considerably easier than inserting two or more stakes into that terrain.

A T-support arm is removably, frictionally attached to a proximal end of the support stake. In a first embodiment, cylindrical polymer foam cushions are disposed along the T-support arm. In this embodiment, one or more surfboards may be laid flat across the pair of supports.

In a second embodiment, the upwardly projecting members are attached to the t-support arm. Each of the upwardly projecting members may also have cylindrical foam cushions. In this embodiment, up to four surfboards may be accommodated on edge between the upwardly projecting members.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a side elevational, schematic view of a first embodiment of a single support stake surfboard support in accordance with the invention;

FIG. 2 is a side elevational, schematic view of the single support stake surfboard support of FIG. 1 further showing a strap;

FIG. 3A is a side elevational, schematic view of the single support stake surfboard support of FIGS. 1 and 2 in a disassembled state and compacted into a bundle;

FIG. 3B is a top, perspective view of the bundle of FIG. 3A;

FIG. 4 is side perspective, schematic view of the pair of single support stake surfboard supports of FIGS. 1 and 2 supporting a surfboard thereupon;

FIG. 5 is a side perspective, schematic view of a single support stake surfboard support of FIGS. 1 and 2 supporting a surfboard thereagainst;

FIG. 6 is a side elevational, schematic view of a second embodiment of a single support stake surfboard support in accordance with the invention;

FIG. 7 is a perspective, schematic view of the dissembled components of the pair of the single support stake surfboard supports of FIG. 6 with a storage/carrying bag; and

FIG. 8 is a perspective, schematic view of a pair of single support stake surf board supports of FIG. 6 with a pair of surf boards disposed on edge thereupon.

### DETAILED DESCRIPTION OF THE PREFERRED EMBODIMENT

The present invention provides a single support stake system for elongated objects, especially surfboards, adapted for beach use in sand or the like. The single support stake supports keep one or more surfboards supported above the surface of the sand and stable enough to avoid the effects of wind on the surface of the surfboard.

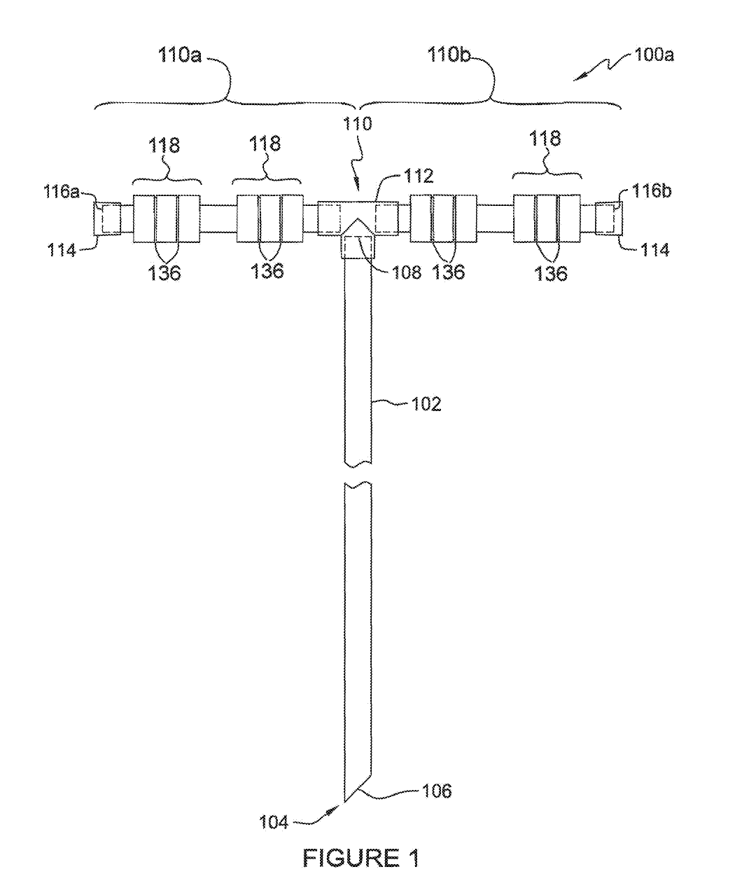

Referring first to FIG. 1, there is shown a side elevational, schematic view of a single support stake surfboard support in accordance with a first embodiment of the invention, generally at reference number 100a.

A support stake 102 is a hollow tube, typically formed from furniture grade plastic (typically PVC) and having a distal end 104. Distal end 104 is cut to an approximately 60° angle to form a “pointed” end 106. Pointed end 106 facilitates pushing distal end 104 of support stake 102 into the sand. It will be recognized that angles other than 60° may be chosen to accommodate a particular operating environment or circumstance and the invention is not considered limited to the 60° angle chosen for purposes of disclosure.

The use of furniture grade plastic rather than metal (e.g., aluminum) provides a material that is softer and less likely scratch or “ding” the delicate surface of a surfboard.

As support stake 102 is pushed downward into sand, sand is pushed into the hollow center of support stake 102. Sand within support stake 102, not specifically identified, acts cooperatively with support stake 102 to provide structural rigidity to support stake 102 and subsequentially, to single support stake surfboard support 100a.

A T-support arm 110, also typically formed from hollow furniture grade plastic has a socket tee pipe fitting 112 F(s) disposed at a midpoint along a major axis of T-support arm 110, thereby substantially bisecting T-support arm 110 into portions 110a, 110b. Socket tee pipe fitting 112 has an opening, not specifically identified, at right angles to a major axis of T-support arm 110 that is sized to accept and frictionally secure a proximal end 108 of support stake 102 therein. Portions of bisected T-support arm 110 are typically chemically bonded to respective side openings of socket tee pipe fitting 112. Solvent bonding of PVC and similar plastics is believed to be well known to those of skill in the art. Consequently, chemical (i.e., solvent) bonding is not further discussed herein.

A cap 114 is attached to each end 116a, 116b of T-support arm 110. Caps 114 keep sand and other debris out of the hollow interior, not specifically identified, of T-support arm 110 as well as providing a smooth, finished edge to ends 116a, 116b.

Cylindrical polymer pads 118 are disposed along T-support arm 110, typically spaced apart from one another. Polymer pads 118 provide a relatively soft structure upon which the surfboard rests and provide additional protection thereto. Cylindrical polymer pads 118 are typically formed from a foamed nirtil butadiene rubber/PVC material that will not crush under the weight of a surfboard resting upon them. Cylindrical polymer pads 118 optionally have a plurality of grooves 136 to allow drainage of water and to prevent sand settling on the T-support arm 110 of other support components. In the embodiment chosen for purposes of disclosure, two grooves 136 are shown in each cylindrical polymer pads 118. This configuration provides clarity in the figures. It will be recognized that each cylindrical polymer pad 118 typically has more than two grooves 136. Also, in the embodiment chosen for purposes of disclosure, cylindrical foam pads 118 are one piece structures manufactured with an inner cylindrical core with additional spaced apart rings formed on the outer surface of the inner core. It will be recognized by those of skill in the art that alternate suitable materials and/or manufacturing methods may be substituted for the foamed nirtil butadiene rubber/PVC chosen for purposes of disclosure. Consequently, the invention is not considered limited to the foamed nitrile butadiene rubber/PVC r chosen for purposes of disclosure. Rather, the invention is intended to include any and all suitable substitute materials and/or manufacturing methods.

In the embodiment chosen for purposes of disclosure cylindrical polymer pads 118 are optionally two-color structures: the inner core is blue and the outer spaced apart rings are black. It will be further recognized by those of skill in the art cylindrical polymer pads 118 may be either a single solid color or that other color combinations may be chosen.

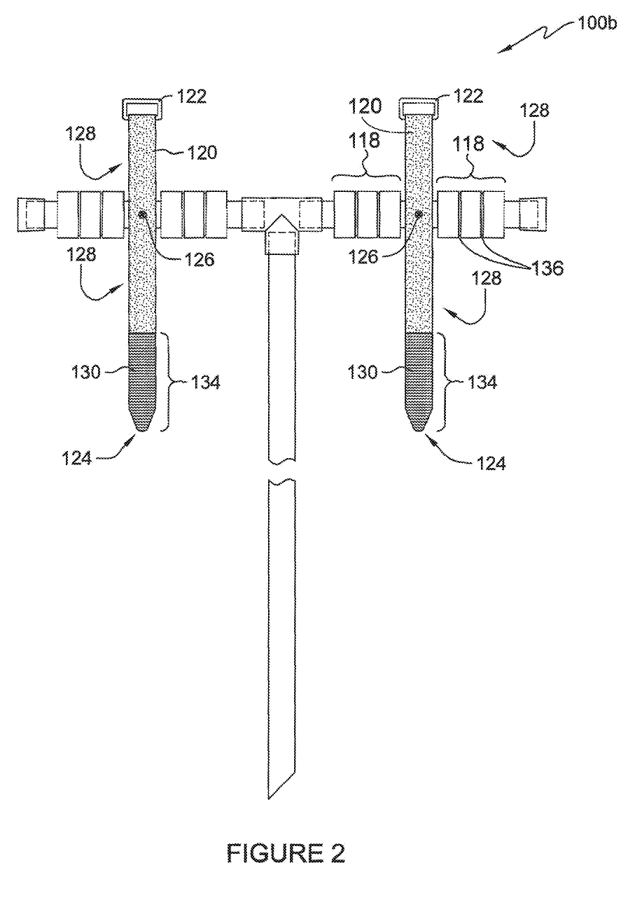

Referring now also to FIG. 2, there is shown a side elevational, schematic view of the single support stake surfboard support of FIG. 1 further showing a strap, generally at reference number 100b. The only difference between surfboard support 100a of FIGS. 1 and 100b is that the surfboard support 100b includes at least one wrapping strap 120.

Straps 120 are affixed to T-support arms 110, typically with a single screw 126 placed through the web material of strap 120 and into the hollow plastic tube forming T-support arm 110. Optionally, straps 120 may be provided as stand-alone objects (i.e., not attached to support arm 110). They may still be carried along with single support stake surfboard support stands 100a, 110b and, when necessary, used to bundle the components thereof.

Straps 120 each have a buckle 122 affixed to a proximal end, not specifically identified.

Distal ends 124 of straps 120 are tapered to form a tongue 130 to facilitate their insertion into respective buckle 122.

Straps 120 each have a loop portion of a hook-and-loop fastening system 128 on a rear surface thereof. Tongue 130 has a hook portion 134 of the hook-and-loop fastening system disposed on an upper surface thereof.

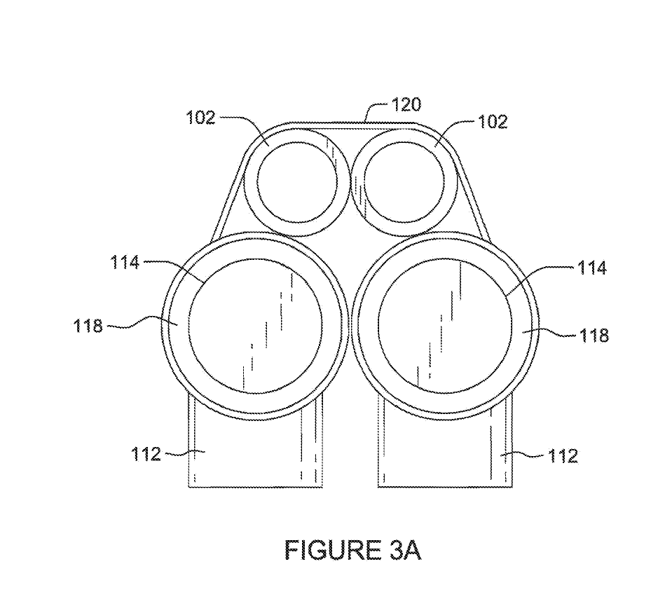

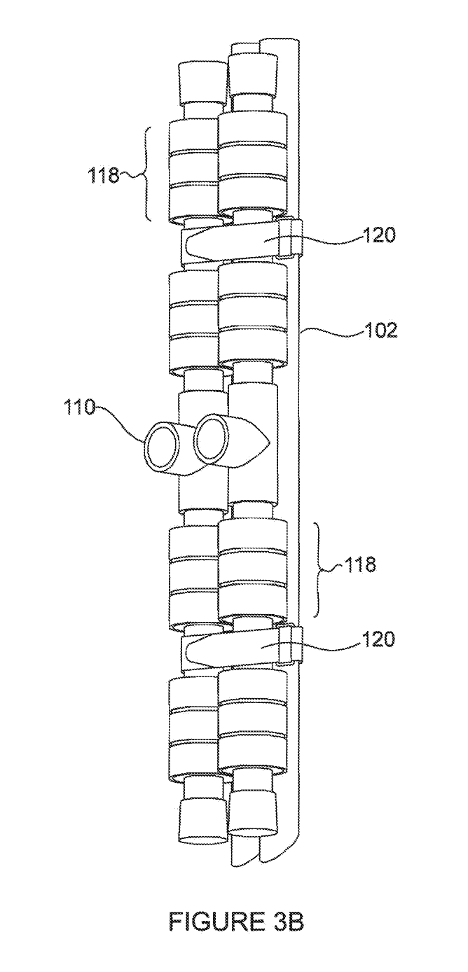

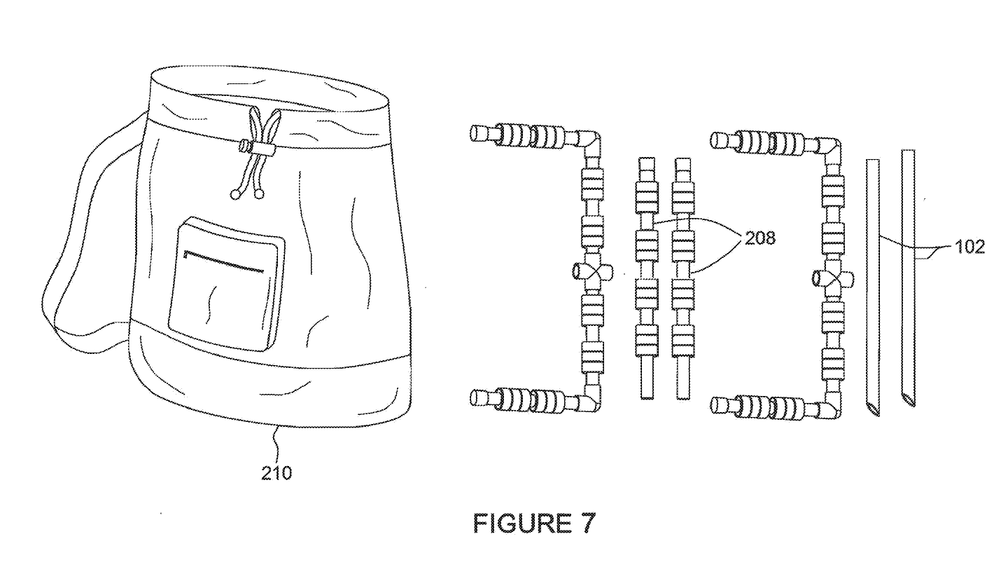

Referring now also to FIG. 3A, there is shown a side elevational view of a pair of single support stake surfboard supports 100a, 100b in a disassembled state and bundled together. A pair of support stakes 102 is laid parallel to a pair of T-support arms 110. Strap(s) 120 are used to secure the assembly for storing or transporting. Alternately, the pair of single stake surfboard supports 100a, 100b may be carried in a carrying bag similar to carrying bag 210 best seen in FIG. 7.

FIG. 3B is a top perspective, schematic view of the bundled supports 110a, 100b as seen in FIG. 3A.

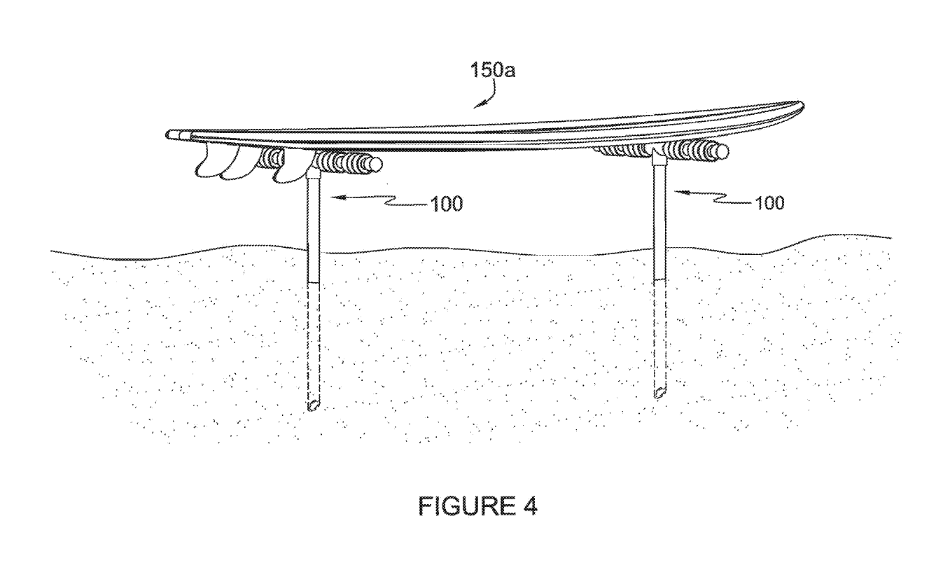

Referring now also to FIG. 4, there is shown a side perspective, schematic view of a pair of single support stake surfboard supports 100a, 100b, typically spaced apart from one another with T-support arms 110 each substantially parallel to one another. The distance between the pair of single support stake surfboard supports 100a, 100b is determined by the length of the surfboard 150a that is to be supported thereupon. It will be recognized that the surfboard 150a illustrated in FIG. 4 forms no part of the present invention and merely illustrates the intended operation of single support stake surfboard supports 100a, 100b.

In use, support stake 102 is inserted into socket tee pipe fittings 112 of respective T-support arms 110a, 100b.

Support stake 102 of each of single support stake surfboard support 100a, 100b is pressed or driven into the sand with T-support arms 110 of each aligned substantially parallel to one another.

Once aligned and, if necessary, adjusted in height to present a level surface for a surfboard 150a to be received and retained upon, the surfboard 150a is laid across T-support arms 110 protected by cylindrical polymer pads 118.

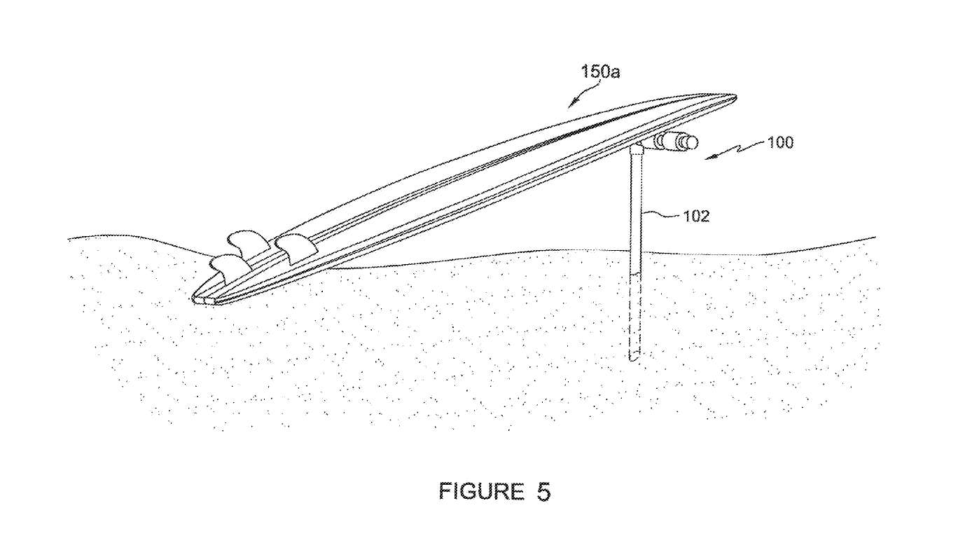

Referring now to FIG. 5, there is a side perspective, schematic view of a single support stake surfboard support 100 with a surfboard 150a leaning thereagainst. This illustrates another configuration in which the novel single support stake surfboard support in accordance with the invention may be utilized.

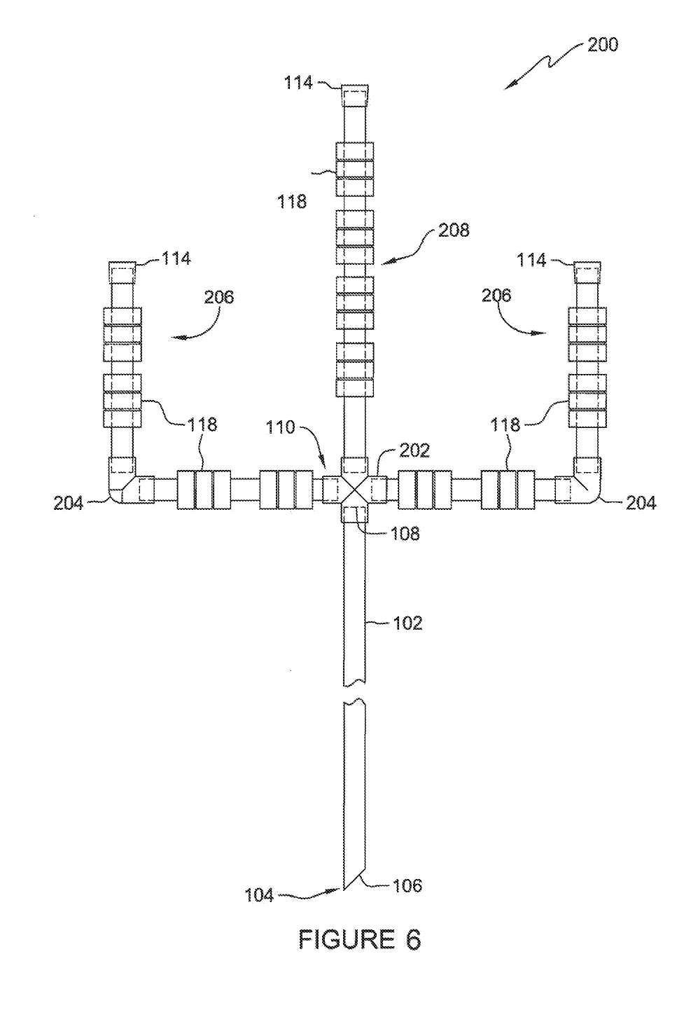

Referring now also to FIG. 6, there is shown a front elevational, schematic view of a second embodiment of a single support stake surfboard support of the invention, generally at reference number 200.

Single support stake surfboard support 200 shares many common features and components with single support stake surfboard supports 100a, 100b.

Single support stake surfboard support 200 uses the same hollow support stake 102 and T-support arm 110. However, socket tee pipe fitting 112 is replaced with a “star” pipe fitting 202. Star pipe fitting 202 is somewhat like socket tee pipe fitting 112 except it has an additional connection point aligned with the connection point in socket tee pipe fitting 112 that accepts proximal end 108 of hollow support stake 102.

Caps 114 at ends 116a, 116b of T-support arm 110 of single support stake surfboard support 100 are replaced with elbow pipe fittings 204. A pair of short upstanding members 206 is connected to upfacing openings in elbow pipe fittings 204. The distal ends, not specifically identified, of respective short upstanding members 206 are terminated with a cap 114.

A longer, central upstanding member 208 is connected to the upfacing opening in star pipe fitting 202. A distal end of central upstanding member 208, not specifically identified, is also terminated with a cap 114.

Unlike single support stake surfboard supports 100a, 100b, single support stake surfboard support 200 is not intended for bundling. Consequently, both of a set of single support stake surfboard supports 200 are identical (i.e., no straps 120 are provided on either of single support stake surfboard supports 200).

Rather than being bundled for storage or transport, the component members of single support stake surfboard supports 200 are adapted for disassembly and packing in a carrying bag 210. Referring now also to FIG. 7, there is shown the dissembled components of a pair of single support stake surfboard supports 200 with a storage/carrying bag 210.

While single support stake surfboard supports 100a, 100b of the first embodiment of the present invention are designed and adapted to support no more than two surfboards, the single support stake surfboard supports of the second embodiment are designed and adapted to support up to four surfboards.

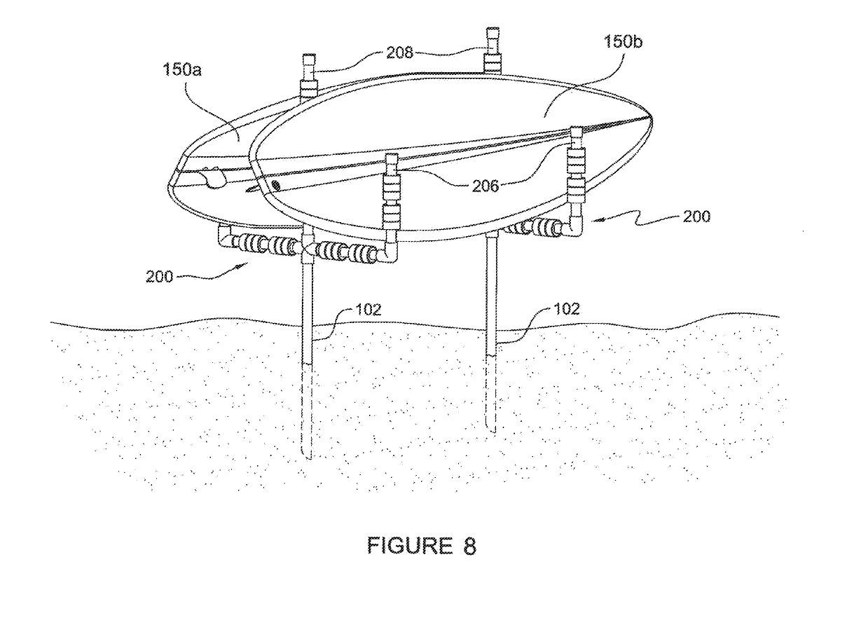

Referring now to FIG. 8, there is shown a side perspective, schematic view of a pair of single support stake surfboard supports 200 with a pair of surf boards 150a, 150b disposed on edge thereupon. It will again be recognized that the surfboard(s) 150a, 150b disposed on single support stake surfboard supports 200 form no part of the present invention.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

1. A single support stake surfboard support for use in a sandy locale, comprising:
a) an elongated hollow support stake having a distal end adapted for forcing downwardly into a sandy surface;
b) a tubular T-support arm having a receptacle disposed at a midpoint along a major axis of said T-support arm, said receptacle being adapted to removably receive and retain a proximal end of said hollow support stake, when connected, said T-support arm being supported perpendicularly to said support stake and substantially level in a horizontal plane; and
c) a plurality of cylindrical polymer pads disposed upon and surrounding said cylindrical T-support arm.

2. The single support stake surfboard support as recited in claim 1, wherein said elongated hollow support stake has a circular cross section and a single diagonal cut adjacent a distal end thereof to facilitate pressing/pounding said support stake into sand.

3. The single support stake surfboard support as recited in claim 2, further comprising:
d) a solid cap affixed to each end of said tubular T-support arm.

4. The single support stake surfboard support as recited in claim 2, further comprising:
d) at least two upwardly projecting tubular members, each having a lower, proximal end affixed to said tubular T-support arm.

5. The single support stake surfboard support as recited in claim 4, wherein at least one selected from the group: at least one of said at least two upwardly projecting tubular members, said tubular T-support arm, and said elongated hollow support stake are formed from furniture grade PVC.

6. The single support stake surfboard support as recited in claim 5, wherein one of said at least two upwardly projecting tubular members is a central upwardly projecting tubular member disposed coaxially with said elongated hollow support stake.

7. The single support stake surfboard support as recited in claim 5, wherein said at least two upwardly projecting circular members further comprises:
e) at least one cylindrical polymer pad disposed around at least one selected from the group: at least one of said at least two upwardly projecting tubular members, and said tubular T-support arm.

8. The single support stake surfboard support as recited in claim 1, wherein said cylindrical polymer pads comprise at least one circumferential groove.

9. The single support stake surfboard support as recited in claim 1, further comprising:
d) at least one elongated flaccid strap having a width and an upper and opposing lower surface, proximal end having a buckle attached thereto, and a tongue formed proximate a distal end, said tongue narrowing to a point.

10. The single support stake surfboard system as recited in claim 9, wherein at least one of said elongated flaccid straps having a middle region attached to said tubular T-support arm of one of said pair of surfboard supports.

11. The single support stake surfboard support as recited in claim 9, wherein said flaccid strap comprises a first portion of a hook-and-loop fastening system disposed on said upper surface of said flaccid strap adjacent said tongue and an opposite portion of said hook-and-loop fastening system disposed on a lower surface of said flaccid strap adjacent said proximal end.

12. The single support stake surfboard support as recited in claim 10, wherein when a first elongated hollow support stake is detached from a first of said tubular T-support arms and laid adjacent and parallel to a second of said elongated hollow support stakes detached from a second of said tubular T-support arms to form a bundle, said at least one strap may encircle said bundle and when said tongue is passed through said buckle, said first portion of said hook-and-loop fastening system is then in contact with said opposite portion of a hook-and-loop fastening system, thereby retaining said bundle.

13. The single support stake surfboard support system as recited in claim 4; further comprising a openable carrying bag sized and configured to receive and retain said T-support arm, said at least two upwardly projecting tubular members, and said elongated hollow support stakes.
